(19) United States
(12) Patent Application Publication
(10) Pub. No.: US 2026/0343385 A1
(43) Pub. Date: Oct. 29, 2026

(54) REDUCING ENERGY CONSUMPTION FOR A WIRELESS COMMUNICATIONS SYSTEM

(71) Applicant: LENOVO (SINGAPORE) PTE. LTD., Singapore (SG)

(72) Inventors: Prateek BASU MALLICK, Dreieich (DE); Joachim LOHR, Wiesbaden (DE); Ravi KUCHIBHOTLA, Chicago (IL); Hyejung JUNG, Palatine, IL (US); Vijay NANGIA, WOODRIDGE, IL (US)

(21) Appl. No.: 19/110,761

(22) PCT Filed: Sep. 21, 2023
(86) PCT No.: PCT/IB2023/059368

§ 371 Date: Mar. 11, 2025

Related U.S. Application Data
(60) Provisional application No. 63/376,921, filed on Sep. 23, 2022.

(51) Int. Cl. H04W 48/16; H04W 36/00; H04W 48/20; H04W 68/00

(52) U.S. Cl. CPC H04W 48/16; H04W 36/0094; H04W 48/20; H04W 68/005

(57) ABSTRACT

Various aspects of the present disclosure relate to reducing energy consumption in wireless communication systems. For example, a network entity may perform operations to determine the states of UEs associated with the network entity, and reduce or modify DL transmissions to the UEs, such as those in RRC Idle states, based on responses received from the UEs. The UEs can assist the network entity by evaluating the geographic area associated with the network entity and providing information about the UEs in the area.

### CROSS REFERENCE TO RELATED APPLICATIONS

This application claims priority to U.S. Provisional Patent Application No. 63/376,921, filed on Sep. 23, 2022, entitled REDUCING ENERGY CONSUMPTION FOR A WIRELESS COMMUNICATIONS SYSTEM, which is hereby incorporated by reference in its entirety.

### TECHNICAL FIELD

The present disclosure relates to wireless communications, and more specifically to reducing energy consumption of components facilitating wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

While the adoption of 5G and technologies beyond 5G enables wireless communications systems to provide enhanced services at high data rates, these enhanced services often rely on denser networks, such as networks having an increasing number of cell sites and/or antennas, larger bandwidths, additional frequency bands, and so on. Further, as the number of devices and services increase, the potential environmental impacts and operating costs due to device emissions and energy consumption can also increase, among other unintended drawbacks.

### SUMMARY

The present disclosure relates to methods, apparatuses, and systems that support reducing energy consumption in a wireless communications system by selectively reducing or modifying transmissions from network entities (e.g., base stations or cells) and UEs served by the network entities.

Some implementations of the method and apparatuses described herein may further include a UE having a processor and a memory coupled with the processor, the processor configured to receive a query message from a network entity, determine, in response to the query message, whether one or more neighbor network entities are available to provide normal service to the UE, and when no neighbor network entities are available to provide normal service to the UE, transmit a message to the network entity.

In some implementations of the method and apparatuses described herein, the UE receives the query message via a short message on a Physical Downlink Control Channel (PDCCH) using a Paging Radio Network Temporary Identifier (P-RNTI).

In some implementations of the method and apparatuses described herein, the UE receives the query message via a radio resource control (RRC) paging message.

In some implementations of the method and apparatuses described herein, the UE is operating in an RRC idle state.

In some implementations of the method and apparatuses described herein, the UE is operating in an RRC inactive state.

In some implementations of the method and apparatuses described herein, the UE determines whether the one or more neighbor network entities are available to provide normal service to the UE by performing intra-frequency measurements or inter-frequency measurements for the one or more neighbor network entities and determining whether the intra-frequency measurements or inter-frequency measurements satisfy one or more cell reselection criteria.

In some implementations of the method and apparatuses described herein, the UE determines, based on intra-frequency measurements or inter-frequency measurements, whether the one or more neighbor network entities satisfies an S-criterion, a new radio (NR) inter-frequency and inter-RAT (radio access technology) cell reselection criteria, or intra-frequency and equal priority inter-frequency cell reselection criteria.

In some implementations of the method and apparatuses described herein, the UE transmits the message to the network entity when the UE determines the network entity is a solitary serving cell for the UE based on performed measurements indicating that none of the one or more neighbor network entities satisfy cell reselection criteria for the UE.

In some implementations of the method and apparatuses described herein, the UE transmits the message to the network entity when the UE determines the network entity is an only available serving cell for the UE based on determining that none of the one or more neighbor network entities are suitable serving cells for the UE.

Some implementations of the method and apparatuses described herein may further include a method performed by a UE the method comprising receiving a query message from a network entity, determining, in response to the query message, whether one or more neighbor network entities are available to provide normal service to the UE and, when no neighbor network entities are available to provide normal service to the UE, transmitting a message to the network entity.

Some implementations of the method and apparatuses described herein may further include a network entity having a processor and a memory coupled with the processor, the processor configured to transmit query messages to one or more UEs, receive response messages from the one or more UEs that indicate, for each UE, whether the UE can select a neighbor network entity as a serving cell, and modify downlink (DL) transmissions to the one or more UEs based on a number of response messages received from the one or more UEs.

In some implementations of the method and apparatuses described herein, the network entity transmits the query message via a short message on a PDCCH using a P-RNTI.

In some implementations of the method and apparatuses described herein, the network entity transmits the query message via an RRC paging message.

In some implementations of the method and apparatuses described herein, the network entity transmits the query message to at least one UE is operating in an RRC idle state.

In some implementations of the method and apparatuses described herein, the network entity transmits the query message to at least one UE operating in an RRC inactive state.

In some implementations of the method and apparatuses described herein, the network entity modifies DL transmissions by reducing Synchronization Signal Blocks (SSBs), Master Information Block (MIB) transmissions, or system information transmissions.

In some implementations of the method and apparatuses described herein, the network entity modifies a periodicity of uplink (UL) reception from the one or more UEs.

In some implementations of the method and apparatuses described herein, the network entity, before modifying DL transmissions, transmits idle mobility commands to the one or more UEs that requests any UEs in an RRC idle state to perform an RRC idle state mobility procedure.

In some implementations of the method and apparatuses described herein, the network entity modifies DL transmissions by selecting a DL transmission modification type based on the number of response messages received from the one or more UEs being within a range of numbers associated with the DL transmission modification type.

In some implementations of the method and apparatuses described herein, the network entity modifies DL transmissions by performing no DL transmissions when the number of response messages received from the one or more UEs is zero, performing sparse DL transmissions when the number of response messages received from the one or more UEs is within a first range of numbers, performing reduced DL transmissions when the number of response messages received from the one or more UEs is within a second range of numbers, an/or performing peak DL transmissions when the number of response messages received from the one or more UEs is above a peak-traffic number of responses.

Some implementations of the method and apparatuses described herein may further include method performed by a network entity, the method comprising transmitting query messages to one or more user equipment (UEs), receiving response messages from the one or more UEs that indicate, for each UE, whether the UE can select a neighbor network entity as a serving cell, and modifying downlink (DL) transmissions to the one or more UEs based on a number of response messages received from the one or more UEs.

### BRIEF DESCRIPTION OF THE DRAWINGS

FIG. 1 illustrates an example of a wireless communications system that supports reducing energy consumption during wireless communications in accordance with aspects of the present disclosure.

FIG. 2 illustrates an example of a diagram that supports messaging between a network entity and one or more UEs in accordance with aspects of the present disclosure.

FIG. 3 illustrates an example of a diagram that supports selection of a communications periodicity in accordance with aspects of the present disclosure.

FIG. 4 illustrates an example of a diagram that supports provisioning neighboring cells into energy saving slots in accordance with aspects of the present disclosure.

FIG. 5 illustrates an example of a block diagram of a device that supports reducing energy consumption during wireless communications in accordance with aspects of the present disclosure.

FIG. 6 illustrates a flowchart of a method that supports a network entity determining the RRC states for UEs in a coverage area in accordance with aspects of the present disclosure.

FIG. 7 illustrates a flowchart of a method that supports a UE evaluating a coverage area of a network entity in accordance with aspects of the present disclosure.

### DETAILED DESCRIPTION

Network communication systems, such as those providing 5G or other enhanced radio access technologies, can inadvertently impact a geographical area due to the number of devices providing enhanced services (e.g., services with high data rates) and/or the amount of network bandwidth utilized when providing such services. For example, while use of additional devices and higher data rates can lead to a more energy efficient network, emissions associated with providing these enhanced services adversely impact the served geographical areas.

To mitigate such drawbacks, a network communication system may implement and/or follow a network energy consumption model that seeks to optimize operations of different components of the network, such as base stations and other network entities. Such a model can balance the deployment of devices with the reduction of energy consumption by modifying device operations in a targeted, selective manner.

For example, a geographical area can often be in a low or medium load scenario, where the number of UEs served by a network entity (e.g., a cell) is relatively low as compared to peak times. Further, a network cell can be associated with many UEs at a given time, but a relatively low number of UEs are in a connected state (e.g., RRC Connected state), as compared to other UE RRC states (e.g., RRC Idle and/or RRC Inactive states.

Thus, the network can perform operations to save or reduce the energy consumption for a cell or other network entity based on the RRC states of UEs associated with the cell. For example, the network may reduce certain access channel transmissions and other DL transmissions for UEs in an RRC Connected state and/or perform handover operations to move these UEs to other cells, such as when there are no longer UEs served by the cell in the RRC Connected state.

The network entity may perform operations to determine the states of UEs associated with the network entity, to reduce DL transmissions to the UEs, such as those in RRC Idle states. The UEs can assist the network entity by evaluating the geographic area associated with the network entity and providing information about the UEs in the area.

Thus, by providing a network entity with state information for associated UEs, the network can minimize or prevent interruptions of service to UEs in RRC Idle states, while also reducing DL transmissions to these UEs, which are idle and/or inactive (e.g., not in a connected state). In doing so, the network can reduce the energy consumed by constant and/or unnecessary transmissions between devices (e.g., between a cell and its associated UEs) with no or minimal impact to the services provided to the UEs, among other benefits.

Aspects of the present disclosure are described in the context of a wireless communications system. Aspects of the present disclosure are further illustrated and described with reference to device diagrams and flowcharts.

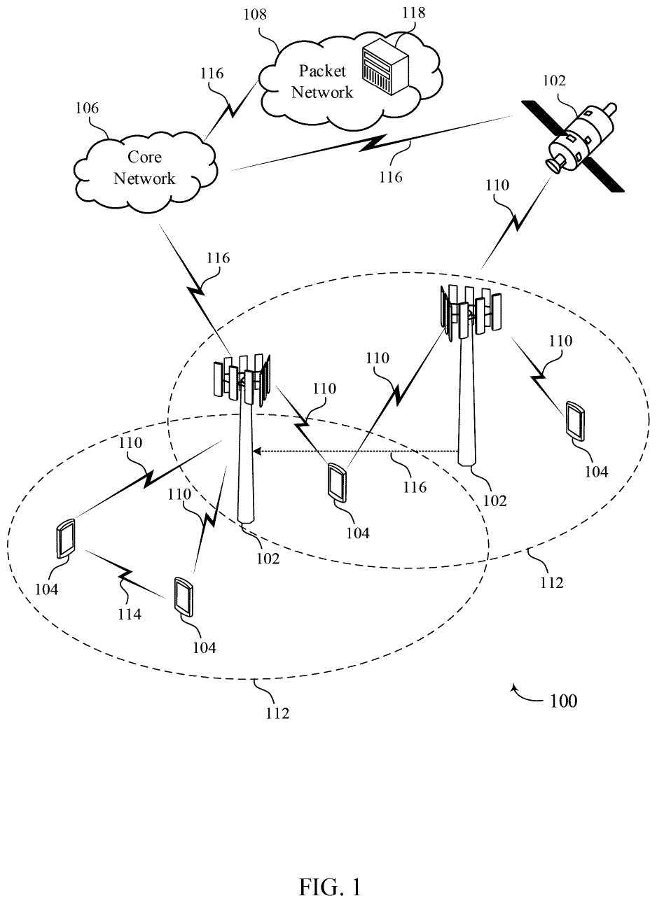

FIG. 1 illustrates an example of a wireless communications system 100 that supports reducing energy consumption during wireless communications in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the network can reduce energy consumption, such as the energy consumption of the base stations 102, by identifying the RRC states for any UEs 104 associated with the base stations 102, and reducing transmissions (e.g., reducing the periodicity of transmissions) between a base station and certain UEs, such as UEs in RRC Idle or Inactive states.

The UE 104 may be in one RRC state (within a 5G network) at any given time. The RRC states include an RRC Connected state (e.g., NR RRC_Connected), an RRC Inactive state (e.g., NR RRC_Inactive), and an RRC Idle state (e.g., NR RRC_Idle). In some cases, the UE 104 can be in the RRC Connected or RRC Inactive state when there is an established RRC connection, and in the RRC Idle state when there is no RRC connection.

In some embodiments, the base station 102, or other network entity, transmits messages to the UEs 104 to determine the RRC states of the UEs 104 and modify transmissions, such as DL transmissions, based on the discovered or determined UE RRC states. For example, the network can reduce certain transmissions (e.g., Synchronization Signal Blocks (SSBs), Master Information Block (MIB) transmissions, and/or system information transmissions) based on the number of UEs in the RRC Idle state and/or the number of UEs transitioning between states (e.g., from RRC Idle to RRC Connected states).

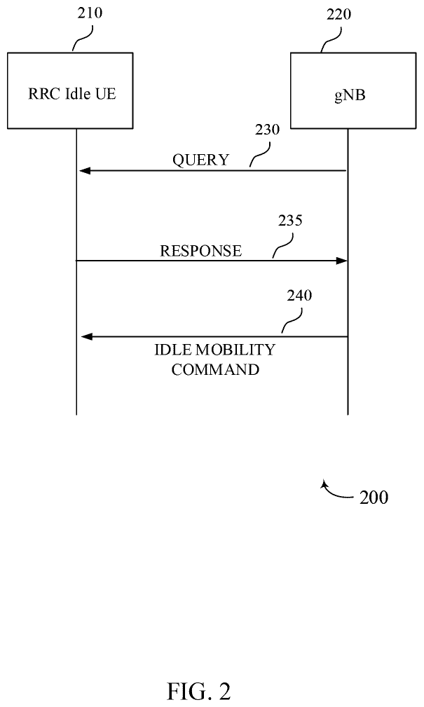

FIG. 2 illustrates an example of a diagram 200 that supports messaging between a network entity and one or more UEs in accordance with aspects of the present disclosure. A network entity 220 (e.g., a gNB in a 5G network) transmits a query message 230 to a UE 210, such as a UE in an RRC Idle state. The query message 230 can be a DL common signaling message (e.g., a new Paging message), which addresses the UE 210 in the RRC Idle state.

The query message 210 queries the UE to provide information regarding the availability of other cells (or other network entities) to operate as a suitable or acceptable serving cell for the UE 210. As an example, a cell can be a suitable or acceptable serving cell when the cell has sufficient radio quality to support an emergency call placed by the UE 210. Thus, the query message 220 causes the UE 210 to determine whether the UE 210 can select (or reselect) a different cell as a suitable or acceptable cell.

In some cases, the query message 210 can request from the UE 210 to evaluate one or more cell selection criteria S, or S-alternative criterion, at different radio thresholds.

The network entity 220 can transmit the query message 230 in different ways. As a first example, the query can be part of an RRC paging message and can optionally include different radio threshold values. The following is an example RRC paging message that includes the query to the UE 210:

```
-- ASNISTART
-- TAG-PAGING-START
Paging ::= SEQUENCE {
        pagingRecordList PagingRecordList OPTIONAL, -- Need N
        lateNonCriticalExtension OCTET STRING  OPTIONAL,
        nonCriticalExtension Paging-v1700-IEs OPTIONAL
}
Paging-v1700-IEs ::= SEQUENCE {
        pagingRecordList-v1700 PagingRecordList-v1700  OPTIONAL,
        pagingGroupList-r17 PagingGroupList-r17 OPTIONAL,
        nonCriticalExtension Query-v1800-IEs OPTIONAL
}
PagingRecordList ::= SEQUENCE (SIZE(1..maxNrofPageRec)) OF PagingRecord
PagingRecordList-v1700 ::= SEQUENCE (SIZE(1..maxNrofPageRec)) OF PagingRecord-
v1700
PagingGroupList-r17 ::= SEQUENCE (SIZE(1..maxNrofPageGroup-r17)) OF TMGI- r17
PagingRecord ::= SEQUENCE {
        ue-Identity PagingUE-Identity,
        accessType ENUMERATED {non3GPP}  OPTIONAL,  -- Need N
        ...
}
PagingRecord-v1700 ::= SEQUENCE {
pagingCause-r17 ENUMERATED {voice} OPTIONAL  -- Need N
}
PagingUE-Identity ::= CHOICE {
        ng-5G-S-TMSI NG-5G-S-TMSI,
        fullI-RNTI I-RNTI-Value,
        ...
}
Query-v1800-IEs ::= SEQUENCE {
        cellSelectionInfo SEQUENCE {
                q-RxLevMin Q-RxLevMin,
                q-RxLevMinOffset INTEGER (1..8) OPTIONAL,  -- Need S
                q-RxLevMinSUL Q-RxLevMin  OPTIONAL,  -- Need R
                q-QualMin Q-QualMin OPTIONAL,  -- Need S
        q-QualMinOffset INTEGER (1..8) OPTIONAL  -- Need S
        } OPTIONAL,
        nonCriticalExtension SEQUENCE { } OPTIONAL
}
-- TAG-PAGING-STOP
-- ASNISTOP
```

As a second example, the network entity can utilize short messages, adding a new code point to signal the query to the UE 210. The network entity can transmit the short message via PDCCH using P-RNTI (with or without associating a Paging message using a short message field in a DCI format 1_0).

Table 1 presents an example implementation, where Bit 5 signals to the UE 210 that the message is a query message:

TABLE 1
Short Messages Extended to include the Query to the UE 210

| Bit | Short Message |
|---|---|
| 1 | systemInfoModification |
| | If set to 1: indication of a BCCH modification other than SIB6, SIB7 and SIB8. |
| 2 | etwsAndCmasIndication |
| | If set to 1: indication of an ETWS primary notification and/or an ETWS secondary notification and/or a |
| | CMAS notification. |
| 3 | stopPagingMonitoring |
| | This bit can be used for only operation with shared spectrum channel access and if nrofPDCCH- |
| | MonitoringOccasionPerSSB-InPO is present. |
| | If set to 1: indication that the UE may stop monitoring PDCCH occasion(s) for paging in this Paging Occasion |
| | as specified in TS 38.304 [20], clause 7.1. |
| 4 | systemInfoModification-eDRX |
| | If set to 1: indication of a BCCH modification other than SIB6, SIB7 and SIB8. This indication applies only to |
| | UEs using eDRX cycle longer than the BCCH modification period. |
| 5 | queryMessage: UE shall behave as defined here. |
| 6-8 | Not used and shall be ignored by UE if received. |

As indicated, the Query message (e.g., Query-v1800-IEs) is included in the SIB1 (or in a different SIB) when the network initiates an energy saving or reduction procedure, where the UE 210 is subsequently informed using systemInfoModification or the newly defined queryMessage in the short message in the PDCCH using P-RNTI, as described herein. Alternatively, the UE 210 can check if the SIB1 (or a different SIB where a query is included) is updated periodically based on a SIB1 periodicity of 160 ms.

In response, the UE 210 transmits a response message 235 to the network entity 220 after evaluating the serving area by performing various measurements. For example, the UE 210 may perform measurements, even if the network entity 220 (e.g., the current serving cell) satisfies the following conditions:
Srxlev>S_{IntraSearchP} and Squal>S_{IntraSearchQ}, to perform intra-frequency measurements; or
Srxlev>S_{nonIntraSearchP} and Squal>S_{nonIntraSearchQ}, a NR inter-frequency with an equal or lower reselection priority,
Where S_{IntraSearchP} specifies the Srxlev (cell selection RX level value) threshold (in dB) for intra-frequency measurements, S_{IntraSearchQ} specifies the Squal (cell selection quality value) threshold (in dB) for intra-frequency measurements, S_{nonIntraSearch} specifies the Srxlev threshold (in dB) for NR inter-frequency and inter-RAT measurements, and S_{nonIntraSearchQ} specifies the Squal threshold (in dB) for NR inter-frequency and inter-RAT measurements.

After performing the measurements, the UE 210 evaluates whether one or more radio criteria are satisfied. For example, the UE 210 can determine that the S-criterion (or S-alternative criterion) is satisfied, that the NR Inter-frequency and inter-RAT Cell Reselection criteria are satisfied, and/or the Intra-frequency and equal priority inter-frequency Cell Reselection criteria are satisfied, among other selection criteria.

In some cases, the UE 210 sends the response message 235 when none of the selection criteria or fulfilled or satisfied. For example, the response message 235 can indicate the current serving cell (e.g., the network entity 220) is the only available suitable cell for the UE 210. Otherwise, the UE 210 may not send the response message 235.

In other cases, the UE 210 sends the response message 235 when the UE 210 determines that zero neighbor cells are acceptable or suitable serving cells. Thus, the response message 235 indicates that the current serving cell (e.g., the network entity 220) is the only available suitable cell for the UE 210. Otherwise, the UE 210 may not send the response message 235.

When the network entity 220 receives zero or less than a threshold number of responses from the various queried UEs 210, such as within a certain time period or window after transmitting the query messages 230, the network entity 220 reduces or stops DL transmissions. For example, the network entity 220 can switch off certain transmissions (e.g., SSBs, MIB and/or System Information) and/or UL reception.

In some embodiments, the network entity 220 can optionally send an idle mobility command (or other DL signaling message) 240 to the UE 210. The command 240 can request RRC Idle UEs (e.g., the UE 210) to perform RRC Idle state mobility operations (e.g., selection or reselection procedures). In some cases, the command 240 can indicate a time or duration at which the network entity 220 turns on transmission/reception operations.

For example, the network entity 220 can continue to transmit SSBs using either a current broadcast configuration or with a reduced periodicity (e.g., identified in the command 240 and/or the messaging configurations described herein) and listens to UL RACH occasions for messages from the UEs in the Idle state.

In some embodiments, the network entity 220 determines or identifies a specific number of the UEs 210 that have sent response messages 235 in response to the query message 230 transmitted by the network entity 220. Using the specific number, N, the network entity 220 can follow a stepwise process to determine how often or at what periodicity to perform DL signaling. Table 2 maps the number N of response messages to the DL transmission periodicity for a given area.

TABLE 2

| No. of UEs transmitting Response < N1 | No DL transmission |
|---|---|
| N1 < No. of UEs transmitting | Sparse DL transmission |
| Response < N2 | |
| N2 < No. of UEs transmitting | DL transmission with somewhat |
| Response < N3 | reduced periodicity |
| N3 < No. of UEs transmitting Response | DL transmission with peak- |
| | traffic situation |

Thus, the DL signaling or transmission of certain types (e.g., SSBs, MIB, SIB1 and/or other system information) is mapped to the number of UEs 210 sending responses to the network entity 220.

For example, given a certain coverage area, the network entity can estimate or determine the number of UEs in an RRC Idle state (with respect to UEs in an RRC Connected state), which can be expressed as a ratio of RRC Idle UEs to RRC Connected UEs. In some cases, the ratio can increase from peak to non-peak hours, where the ratio goes from 10:1 to 50:1. In such cases, the N in Table 2 can represent the actual number of UEs sending the response message, or the ratio of RRC Idle UEs to RRC Connected UEs. Thus, following Table 2, the DL transmission periodicity changes as the number of UEs sending response messages changes.

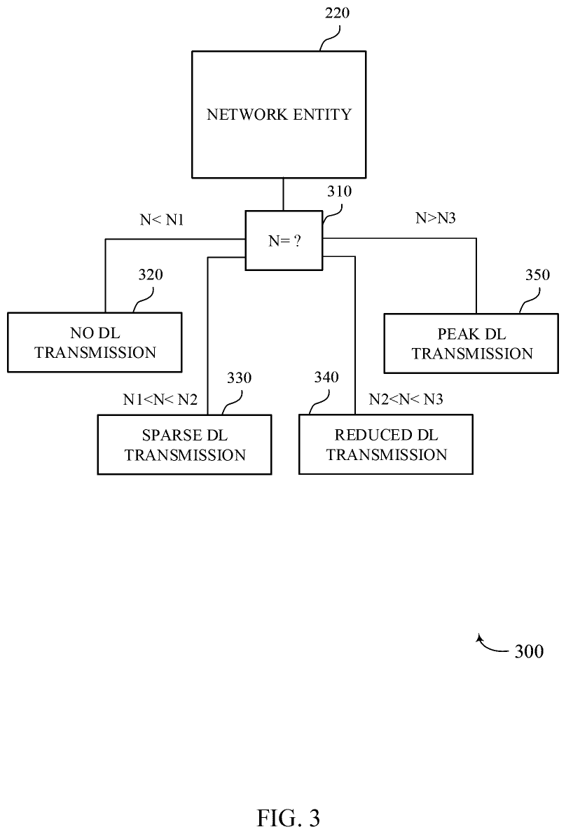

The network, therefore, can adjust DL transmission periodicity based on various conditions, such as when there are no (or minimum) Idle UEs in the cell (e.g., in sparsely populated areas and/or when the average number of UEs transitioning to the RRC Connected state from RRC Idle state is low (e.g., during non-peak hours for the coverage area). FIG. 3 illustrates an example of a diagram 300 that supports selection of a communications periodicity in accordance with aspects of the present disclosure.

As shown, the network entity 220 determines the number N of response messages 310 received after sending the query message 230. Based on the number N, the network entity 220 performs no DL transmissions 320, performs sparse or few DL transmissions 330, performs a reduced number of DL transmissions 340, or performs at a peak level (e.g., non-reduced) of periodicity 350.

The thresholds N1, N2, N3, and N4 can vary, depending on the coverage area, time of day, and so on. For example, the thresholds can be based on absolute numbers, where N1=1 and the other thresholds increase in a linear fashion. As another example, the threshold can increase exponentially (e.g., N1=3, N2=9, N3=27, N4=81). Further, the network can include fewer or more thresholds, modifying the granularity of the stepwise process based on the network and/or its characteristics.

In some embodiment, such as when the network entity 220 reduces the periodicity of DL transmissions, the UEs 210 can monitor radio quality within the coverage area during certain energy saving period (e.g., when DL transmissions are reduced). While monitoring the coverage area, the UEs 210 can:
Report a measured serving cell quality, unconditionally or conditionally, upon the quality meeting a threshold (e.g., S-Criterion, Alternative S-Criterion, and so on), which may be a new threshold that indicates the serving cell has gone below the new threshold;
Report when at least one neighbor cell satisfies one or more of the quality thresholds;
Logs any generated reports, providing the reports to the network entity 220 when the network entity 220 returns to an original DL transmission periodicity; and so on.

In some cases, the UE 210 considers a newly advertised DL transmission configuration to determine the cell quality. For example, the UE 210 can apply an L1 and/or L3 filtering to evaluate a cell radio quality utilizes the new configuration of the DL transmission to avoid erroneous determinations that a cell is a weak radio cell. Thus, the UE can avoid false determinations of a cell temporarily saving energy by reducing DL transmission(s) as a weak cell, among other things.

In some embodiments, the network entity 220 can communicate with other entities (other cells) to prevent or avoid numerous neighboring cells from reducing DL transmissions or going into sleep modes. For example, before sending the query message 230 to the UEs 210, the network entity 210 can poll neighbor cells to determine whether the neighbor cells are or will remain active and available to able to any UEs being served by the cells.

In some cases, the neighboring cells can communicate with one another to determine which cells may move to an energy saving mode (e.g., reducing DL transmissions). The cells, based on the responses, can introduce a TDM (time-division multiplexing) pattern and place different cells into different slots.

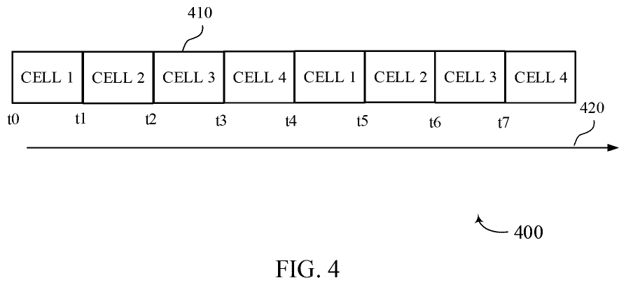

FIG. 4 illustrates an example of a diagram 400 that supports provisioning neighboring cells into energy saving slots in accordance with aspects of the present disclosure. The cells 410 are positioned or slotted on a timeline 420 of different time periods (e.g., t0 to t1, t4 to t5, and so on). Within each time period, a certain cell 410 can perform a DL transmission reduction or modification as described herein. However, when DL transmission is not possible at the time of sending the query message 230, the cell 410 can inform the cell next in the timeline 420, which may initiate its DL reduction procedure before its associated time slot commences.

For example, when cell 3 attempts to sleep or otherwise reduce DL transmissions upon the timeline reaching t2, the cell receives too many response messages 235, and cannot modify operations. Cell 3 then informs Cell 4, which sends the query messages 230 before t3, which is the cell's normally allotted time to perform energy saving operations, because Cell 3 cannot take advantage of its slotted time to perform energy saving.

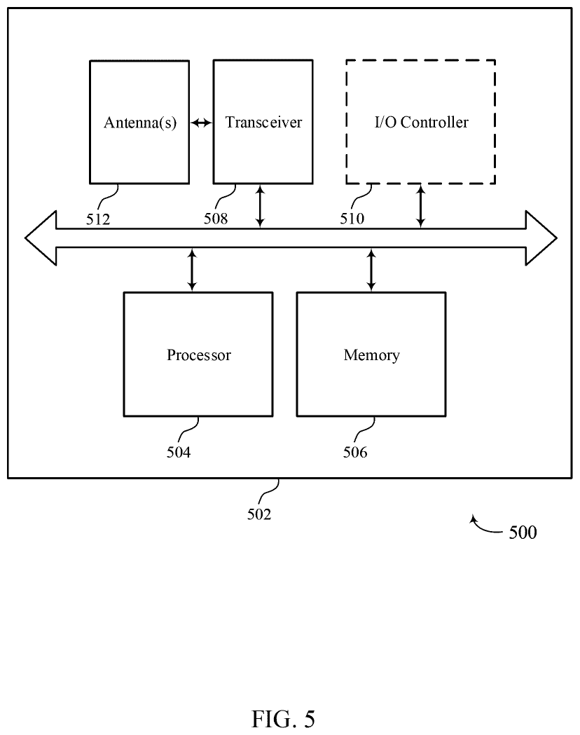

FIG. 5 illustrates an example of a block diagram 500 of a device 502 that supports reducing energy consumption during wireless communications in accordance with aspects of the present disclosure. The device 502 may be an example of a network entity 102 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for transmitting query messages to one or more UEs, receiving response messages from the one or more UEs that indicate, for each UE, whether the UE can select a neighbor network entity as a serving cell, and DL transmissions to the one or more UEs based on a number of response messages received from the one or more UEs.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor M06. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

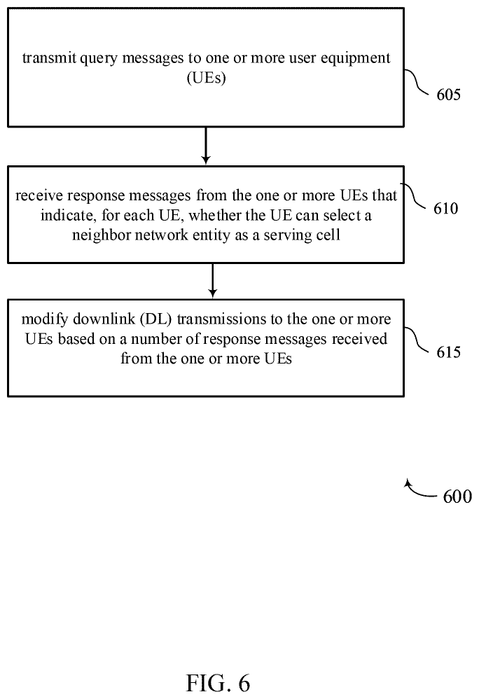

FIG. 6 illustrates a flowchart of a method 600 that supports a network entity determining the RRC states for UEs in a coverage area in accordance with aspects of the present disclosure. The operations of the method 600 may be implemented by a device or its components as described herein. For example, the operations of the method 600 may be performed by the network entity 102 or network entity 220 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 605, the method may include transmitting query messages to one or more UEs. The operations of 605 may be performed in accordance with examples as described herein. In some implementations, aspects of the operations of 605 may be performed by a device as described with reference to FIG. 1.

At 610, the method may include receiving response messages from the one or more UEs that indicate, for each UE, whether the UE can select a neighbor network entity as a serving cell. The operations of 610 may be performed in accordance with examples as described herein. In some implementations, aspects of the operations of 610 may be performed by a device as described with reference to FIG. 1.

At 615, the method may include modifying DL transmissions to the one or more UEs based on a number of response messages received from the one or more UEs. The operations of 615 may be performed in accordance with examples as described herein. In some implementations, aspects of the operations of 615 may be performed by a device as described with reference to FIG. 1.

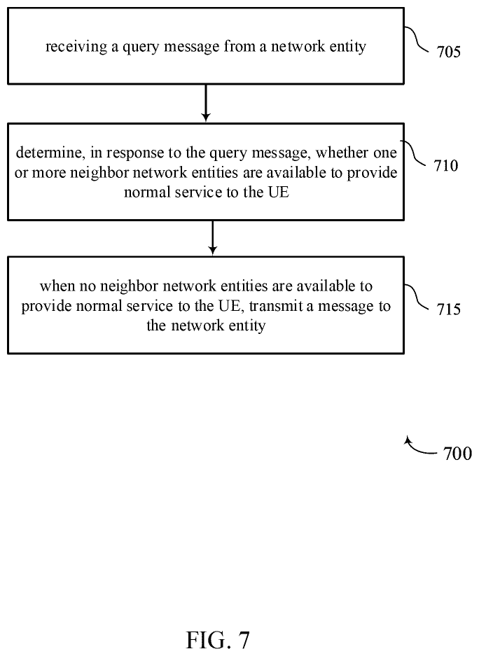

FIG. 7 illustrates a flowchart of a method 700 that supports a UE evaluating a coverage area of a network entity in accordance with aspects of the present disclosure. The operations of the method 700 may be implemented by a device or its components as described herein. For example, the operations of the method 700 may be performed by the network entity 102 or network entity 220 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 705, the method may include receiving a query message from a network entity. The operations of 705 may be performed in accordance with examples as described herein. In some implementations, aspects of the operations of 616 may be performed by a device as described with reference to FIG. 1.

At 710, the method may include determining, in response to the query message, whether one or more neighbor network entities are available to provide normal service to the UE. The operations of 710 may be performed in accordance with examples as described herein. In some implementations, aspects of the operations of 710 may be performed by a device as described with reference to FIG. 1.

At 715, the method may include, when no neighbor network entities are available to provide normal service to the UE, transmitting a message to the network entity. The operations of 715 may be performed in accordance with examples as described herein. In some implementations, aspects of the operations of 715 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein

1. A user equipment (UE) for wireless communication, comprising:
at least one memory; and
at least one processor coupled with the at least one memory and configured to cause the UE to:
receive a query message from a network entity;
determine, in response to the query message, whether one or more neighbor network entities are available to provide normal service to the UE; and
when no neighbor network entities are available to provide normal service to the UE, transmit a message to the network entity.

2. The UE of claim 1, wherein the UE receives the query message via a short message on a Physical Downlink Control Channel (PDCCH) using a Paging Radio Network Temporary Identifier (P-RNTI).

3. The UE of claim 1, wherein the UE receives the query message via a radio resource control (RRC) paging message.

4. The UE of claim 1, wherein the UE is operating in a radio resource control (RRC) idle state.

5. The UE of claim 1, wherein the UE is operating in a radio resource control (RRC) inactive state.

6. The UE of claim 1, wherein the at least one processor is configured to cause the UE to determine whether the one or more neighbor network entities are available to provide normal service to the UE by:
performing intra-frequency measurements or inter-frequency measurements for the one or more neighbor network entities; and
determining whether the intra-frequency measurements or inter-frequency measurements satisfy one or more cell reselection criteria.

7. The UE of claim 1, wherein the at least one processor is further configured to cause the UE to determine, based on intra-frequency measurements or inter-frequency measurements, whether the one or more neighbor network entities satisfies:
an S-criterion,
new radio (NR) inter-frequency and inter-RAT (radio access technology) cell reselection criteria, or
intra-frequency and equal priority inter-frequency cell reselection criteria.

8. The UE of claim 1, wherein the at least one processor is configured to cause the UE to transmit the message to the network entity when the UE determines the network entity is a solitary serving cell for the UE based on performed measurements indicating that none of the one or more neighbor network entities satisfy cell reselection criteria for the UE.

9. The UE of claim 1, wherein the at least one processor is configured to cause the UE to transmit the message to the network entity when the UE determines the network entity is an only available serving cell for the UE based on determining that none of the one or more neighbor network entities are suitable serving cells for the UE.

10. A method performed by a user equipment (UE), the method comprising:
receiving a query message from a network entity;
determining, in response to the query message, whether one or more neighbor network entities are available to provide normal service to the UE; and
when no neighbor network entities are available to provide normal service to the UE, transmitting a message to the network entity.

11. The method of claim 10, wherein the UE receives the query message via a short message on a Physical Downlink Control Channel (PDCCH) using a Paging Radio Network Temporary Identifier (P-RNTI).

12. The method of claim 10, wherein the UE receives the query message via a radio resource control (RRC) paging message.

13. A network entity for wireless communication, comprising:
at least one memory; and
at least one processor coupled with the at least one memory and configured to cause the network entity to:
transmit query messages to one or more user equipment (UEs);
receive response messages from the one or more UEs that indicate, for each UE, whether the UE can select a neighbor network entity as a serving cell; and
modify downlink (DL) transmissions to the one or more UEs based on a number of response messages received from the one or more UEs.

14. The network entity of claim 13, wherein the at least one processor is configured to cause the network entity to transmit the query messages via a short message on a Physical Downlink Control Channel (PDCCH) using a Paging Radio Network Temporary Identifier (P-RNTI).

15. The network entity of claim 13, wherein the at least one processor is configured to cause the network entity to transmit the query messages via a radio resource control (RRC) paging message.

16. (canceled)

17. (canceled)

18. The network entity of claim 13, wherein the at least one processor is configured to cause the network entity to modify the DL transmissions by reducing Synchronization Signal Blocks (SSBs), Master Information Block (MB) transmissions, or system information transmissions.

19. The network entity of claim 13, wherein the at least one processor is configured to cause the network entity to modify a periodicity of uplink reception from the one or more UEs.

20. (canceled)

21. A method performed by a network entity for wireless communication, the method comprising:
transmitting query messages to one or more user equipment (UEs);
receiving response messages from the one or more UEs that indicate, for each UE, whether the UE can select a neighbor network entity as a serving cell; and
modifying downlink (DL) transmissions to the one or more UEs based on a number of response messages received from the one or more UEs.

22. The method of claim 21, wherein transmitting the query messages includes transmitting the query messages via a short message on a Physical Downlink Control Channel (PDCCH) using a Paging Radio Network Temporary Identifier (P-RNTI).

23. The method of claim 21, wherein transmitting the query messages includes transmitting the query messages via a radio resource control (RRC) paging message.
